(19) United States
(12) Patent Application Publication
(10) Pub. No.: US 2019/0228628 A1
(43) Pub. Date: Jul. 25, 2019

(54) AUDIO MONITORING SYSTEM

(71) Applicant: CARU AG, Zürich (CH)

(72) Inventors: Susanne DRÖSCHER, Zürich (CH); Thomas HELBLING, Frauenfeld (CH)

(73) Assignee: CARU AG, Zürich (CH)

(21) Appl. No.: 16/334,817

(22) PCT Filed: Sep. 22, 2017
(86) PCT No.: PCT/EP2017/074098

§ 371 Date: Mar. 20, 2019

(30) Foreign Application Priority Data
Sep. 23, 2016 (CH) 01242/16

(51) Int. Cl. G08B 21/02; G06F 3/16; G08B 3/10; G10L 15/26

(52) U.S. Cl. CPC G08B 21/02; G10L 15/26; G08B 3/1016; G06F 3/167

(57) ABSTRACT

An audio monitoring system provides assistance from an external caregiver to a monitored person in need as efficiently as possible, and limits false alarms. To achieve this, audio signals in a monitored environment are continuously detected by a monitoring system and are explicitly not stored if there is no emergency situation. The incoming audio signal is analysed and classified by noise and speech recognition methods. If an emergency situation is identified, an audio recording is started, and a local alarm is initially sounded which the monitored person can acknowledge within a defined period of time. A remote caregiver is only contacted if no acknowledgement occurs. This method limits the number of false alarms. The audio recording is made available to the remote caregiver, who can therefore assess the emergency situation and development of the situation. Furthermore, an audio connection to the monitored person is established.

### TECHNICAL FIELD

The present invention describes a monitoring method for monitoring a person by means of at least one electronic monitoring unit in a room, with the electronic monitoring unit comprising a hands-free speaking system and at least one audio module so that the audio signals of the monitored person can be detected and analyzed and, if an event is detected, a communication connection with at least one remote caregiver can be established.

A monitoring system comprising at least one electronic monitoring unit which is placed in the center of a closed environment (e.g., a living environment). This electronic monitoring unit detects acoustic signals and other room parameters, for example, temperature, CO2, pressure. The acoustic signal is analyzed by means of voice recognition methods. If acoustic events or voice elements indicating an emergency situation are detected, an alarm is triggered. The triggered alarm initially informs within the closed environment and can be acknowledged. If it is not acknowledged within a defined period of time, a remote caregiver is alerted. The remote caregiver can establish contact with the monitored person in distress via a hands-free speaking system.

### BACKGROUND OF THE INVENTION

An increasing number of people are living alone or are alone in a closed environment for a certain period of time in spite of the fact that they are impaired for reasons of health or age.

A number of different systems are known by means of which an alarm for helping elderly or sick persons, children or babies or animals, or quite generally for individuals in emergency situations, can be sounded. Emergency situations can arise as a result of a fall, an injury, immobility, a weak spell, other acute medical problems, but also as a result of smoke emission, fire, gas leaks, water damage or a threat posed by other living beings (e.g., a burglary, injury by a pet).

On the one hand, there are mobile devices worn on the body which record physiological signals and which, on detection of danger, trigger an alarm, and other devices on which an alarm can be actively triggered. Mobile devices can consist of a sensor, for example, an emergency call button, or a complete system, for example, a smartwatch or a mobile telephone.

On the other hand, there are stationary systems which are able to record physiological or non-physiological signals by means of distributed or central sensors in a closed environment and detect an emergency situation and, based thereon, trigger an alarm.

Stationary systems can either be fixedly installed, for example, on the ceiling, in or on a wall or on the floor. Other systems are stationarily installed but can be moved at any time to a different position. To effectively monitor, for example, an apartment, it is in most cases necessary to install a sensor system in every room.

Stationary systems frequently operate with distributed sensors which are mounted on doors, on windows, on the refrigerator, on the bed, on the ceiling, on the walls, in the shower, in the kitchen near the stove or on medicine dispensers. The installation and maintenance of such sensors is technically complex. The distributed sensors communicate wirelessly or via cable connections and are battery-operated or connected to the stationary power network. These sensors record non-physiological signals, such as temperature, pressure, humidity, smoke, various gases in the air, such as CO2, movement and brightness, or they continuously capture camera images, which limits the privacy of a monitored person considerably.

A variety of different methods for the detection of an emergency situation are known. In one case, monitored persons trigger an alarm by means of active interaction (e.g., by pressing a button or a voice command), while in another case, an emergency situation is detected by means of the analysis of different sensor signals without the active cooperation of the monitored person. The largely automated detection of emergency situations has considerable advantages, but it is also associated with an increased number of false alarms.

EP 1371043 describes a stationary system. The system continuously captures image or audio data of the monitored environment, stores a certain period of time and classifies it. If based on the classification, an emergency situation is determined, an alarm notification is automatically sent to a remote caregiver. Together with the alarm, data from the time prior to the onset of the event are transmitted to this caretaker, said data being audio, video and/or image information recorded prior to the onset of the event.

To be able to send data preceding the event that triggers the alarm, the sensor signals have to be continuously captured and stored in the system. From the point of view of the protection of privacy, this is risky. Since captured data are transmitted from the time before the onset of the event, the monitored person is unable to have an active influence on the information that is being transmitted. Furthermore, the receiving party cannot assess how the situation has developed after the event. The automatic classification of events by means of algorithms leads to false alarms. The false alarms cannot be monitored and controlled by the monitored person.

### DISCLOSURE OF THE CLAIMED INVENTION

The problem to be solved by the present invention is that of how to make available a monitoring method for monitoring a person by means of at least one electronic monitoring unit in a room, which method has a reduced rate of false alarms and eliminates the need for continuously capturing audio and/or video signals.

The objective was to make available an easily installable and low-maintenance stationarily operating electronic monitoring unit which dispenses with battery-operated sensors, which is not worn on the body and which automatically detects emergency situations by means of sound classification and voice detection and generates and transmits an automatic alarm notification.

Another problem to be solved by the present invention was that of how to make available a monitoring system which is able to detect sources of sounds even outside the room in which it is installed, thereby eliminating the need for a separate system for each room.

In addition, the present invention also has the object of making available an alarm system which allows false alarms to be intercepted by a monitored person and which makes it possible to send audio data independently of a direct telephone connection to a remote caregiver.

According to the present invention, by using this alarm system, the rate of false alarms is reduced, and the remote caregiver receives the information in an audio file regardless of whether or not the caregiver was reached by telephone at the time of an emergency situation. This reduces the stress on the family members.

Another problem to be solved by the present invention was that of how to better protect the privacy of the monitored person in that no data from the time that precedes the alarm-triggering event are recorded and sent.

### BRIEF DESCRIPTION OF THE FIGURES

Preferred practical examples of the subject matter of the present invention of an audio monitoring system and a method for monitoring and sounding an alarm will be described below with reference to the appended figures.

FIG. 1: Schematic representation of the configuration of a plurality of sensor units according to one of the possible implementations of the invention.

FIG. 2: Layout of the hardware components and their interconnection which make one of the described implementations of the invention possible.

FIG. 3: Flow chart of the overall monitoring method as described in one of the implementations of the invention.

FIGS. 4a to 4c: Flow charts and chronological sequence of the individual steps of the monitoring method on occurrence of an event.

### DETAILED DESCRIPTION

The system comprises at least one electronic monitoring unit 131, which is here also referred to as master unit, with at least one hands-free speaking system 230, which comprises at least one audio receiver 234 and one loudspeaker 232, as well as a data processing unit 250 and a communication module 282, 284, said electronic monitoring unit being installed in a monitored room 130.

The electronic monitoring unit 131 detects and analyzes audio data and environmental data of the surroundings and classifies these data. If a sound falls within a previously defined class, there is a trigger signal 301, and a local alarm is issued 402. The monitored person has the possibility to acknowledge this alarm within a defined period of time. Furthermore, as the trigger signal 301 is issued, an audio recording 401 is started. If, after expiration of an acknowledgment period 532, no acknowledgment is made, a first portion of an audio recording 524 is transmitted, and a voice connection with a remote caregiver is established 460.

### Hardware

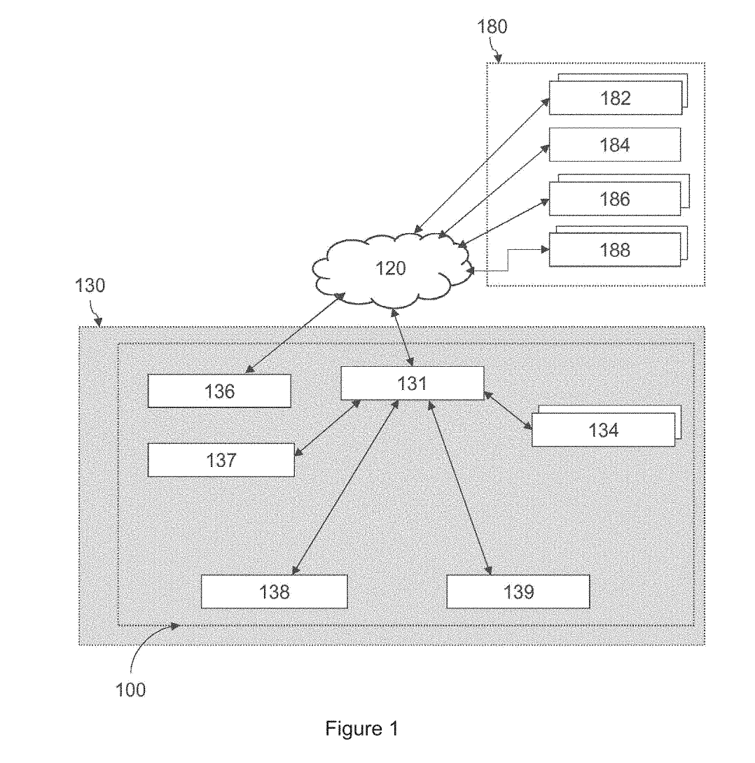

FIG. 1 shows a possible configuration of a monitoring system 100 which comprises one or a plurality of electronic monitoring units (master 131 and slave 134 units) and which may contain additional modules 136, 137, 138, 139.

The electronic monitoring unit 131 is installed in a monitored environment 130, for example, an apartment, an office, a workshop or the like, which environment consists of one or a plurality of rooms. The monitored person resides in this monitored environment.

This electronic monitoring master unit 131 can be connected via a wire-based or wireless data connection system or a voice connection system 120 to at least one external communication device 180. The communication usually takes place by means of an instant messaging service via the Internet or an application via the Internet and/or a mobile radio network (GSM, GPRS, UMTS, LTE) 120. External communication systems are devices, such as smart devices 188 (e.g., smartphones, tablets, smartwatches or the like), telephones 186, emergency call centers 184 or even devices using artificial intelligence 182.

In addition to the electronic monitoring master unit 131, the monitoring system 100 can comprise one or a plurality of electronic monitoring slave units 134 in order to be able to more effectively cover the monitored environment 130. These slave units 134 can be installed within the monitored environment 130 in another area of the same room or in a different room which is acoustically separated from the room in which the electronic monitoring master unit 131 is located. For communication between the slave unit 134 and the master unit 131, conventional radio standards (Bluetooth, Wi-Fi, DECT) are used.

Furthermore, one or a plurality of additional sensor or actor modules 139 or mobile modules, such as robots, for example, with artificial intelligence 138, can be installed within the monitored environment 130, which modules communicate via a wireless connection with the electronic monitoring master unit 131. Such modules are also able to manage smart home application functions, such as controlling the heating system or the louvered blinds or other tasks to support the monitored person. It is also possible for an additional independent electronic monitoring master unit 136 to be installed within the monitored environment 130.

For the setup and configuration of the electronic monitoring master unit 131, an internal wireless data connection via Bluetooth, Wi-Fi, DECT or similar conventional radio standards can be established by a monitored person or another person via the smart device 137, such as a smartphone, a tablet or the like. For the setup and configuration, a data connection can also be established by an external smart device 188 via an external connection 120, such as the cloud.

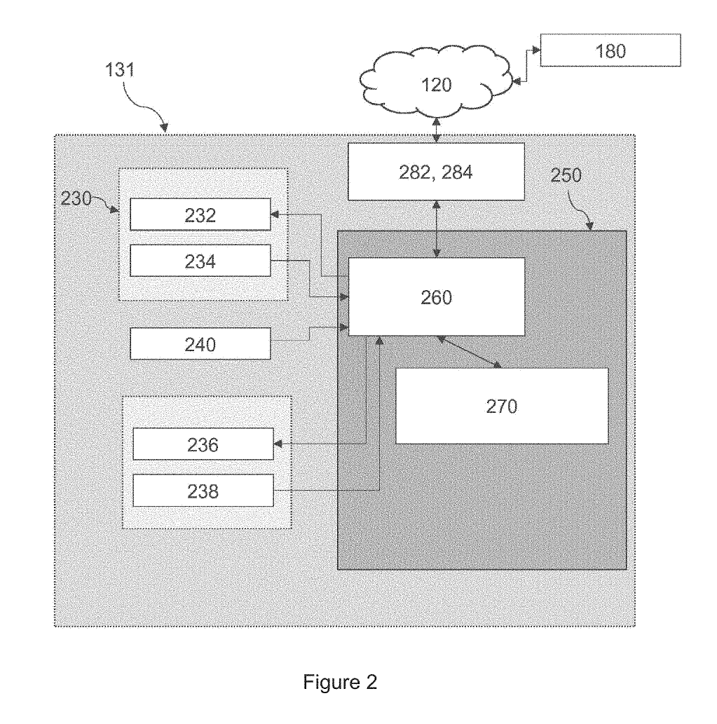

FIG. 2 shows an embodiment of the electronic monitoring master unit 131. The electronic monitoring master unit 131 comprises a hands-free speaking system 230 consisting of an audio receiver 234 and a loudspeaker 232. The audio receiver 234 can be a single microphone, but it is preferably optimized to meet the requirements of far-field recording; for example, by the arrangement of a plurality of microphones in an array.

The electronic monitoring master unit 131 can comprise additional sensors 240 which capture environmental data of the monitored surroundings, for example, a motion sensor, a temperature sensor, a moisture sensor, a gas sensor, especially a CO2 sensor, a camera (including an infrared camera and time-of-flight sensors), radar or other sensors known to those skilled in the art, which allow environmental data to be captured.

The analysis of these sensor data by means of methods known to those skilled in the art makes it possible, for example, to assess the occupancy probability of a room. By adjusting the sound classification using these additional sensor signals, the robustness of the sound classification can be increased. In addition, through the data analysis of the environmental data over relatively large periods of time, normal behavioral patterns of the person can be learned by methods of machine learning. This allows environmental data to be used to detect long-term changes in the behavior of the monitored person and thereby to detect gradual degenerative patterns at an early time. Furthermore, suddenly occurring deviations from the learned normal behavioral pattern can identify a situation in which an individual needs help.

In addition, the room sensor data can also be used to increase the well-being of a person in the room in that feedback is provided via an app which runs on the smart device 184 or via a voice feedback through the loudspeakers 232 in the electronic monitoring unit 131. The feedback can also be transmitted to additional devices 138, 139 in order to take suitable measures for improving the well-being within the monitored environment 130.

The electronic monitoring unit 131 comprises a device for issuing a local alarm 236 and an additional device for the acknowledgment 238 of this local alarm. An alarm signal can be any type of clearly audible and detectable acoustic signal (e.g., music, voice, siren, piping or peeping), optical signal, such as displays on a screen (e.g., a danger signal, flashing or a message), or light signal (e.g., flashing, changes in the intensity of light or the color of light) or a combination of a plurality of these signals. These signals can also be adjusted with respect to intensity, time or type to the danger level of the emergency situation.

Data collection, storage, processing and analysis is performed in a data processing unit 250. A hardware module 260 of the data processing unit is based on one or a plurality of processors and one or a plurality of storage devices. A software module 270 of the data processing unit contains software for processing incoming signals, for example, signals from the audio receiver and the other sensors, as well as the acknowledgment signal. It also contains software for analyzing the data and software for sound and voice detection for the audio data and for sensor fusion and machine learning of the additional sensor data. In addition, software is available, which controls the signal output, such as the alarm output and the loudspeaker output. In addition, software for data storage is executably stored in this module 250. Hereinafter, the entire hardware and software required for processing and analyzing the audio signal will be referred to as “audio module.”

If an alarm is sounded, a remote caregiver is contacted. For communication with this remote caregiver, conventional data channels, such as an instant messaging service via the Internet or an application via the Internet and/or a mobile radio network (GSM, GPRS, UMTS, LTE) 120, and external communication devices 180 are used. For this communication, an external communication module 284 is used, which contains hardware designed for the external communication as well as the associated software.

The master unit and each slave may each have its own direct power supply through the power network and need not be battery-operated.

In a possible embodiment, the data are not locally analyzed, but are transmitted to an external server (e.g., a cloud server) 120 where they are analyzed. The result of the analysis is subsequently communicated back to the master unit 131 and can also be made available to the monitored person and/or the remote caregivers directly by the server.

As FIG. 1 illustrates, in addition to the electronic monitoring master unit 131, additional units can be installed. These slave units 134 are a simplified version of the master unit 131. The wireless radio connection between the slave unit 134 and the master unit 131 is established by means of an internal communication module 282 with the required hardware and the associated software, which internal communication module is integrated into the two monitoring units. In the preferred embodiment, the slave units 134 contain all of the components that the master unit 131 has, except for the external communication module 284.

In another embodiment, individual steps or a plurality of steps of data collection, storage, processing and analysis can be shifted from the slave unit 134 to the unit master 131.

Furthermore, the slave unit 134 need not have an audio receiver 234, a loudspeaker 232, additional sensors 240, a device for issuing a local alarm 236 and a device for acknowledgment 238. It may also contain only one or a plurality of these components.

In a possible embodiment, the slave unit 134 is, for example, a single sensor with an internal communication module 282 which transmits the data directly to the master unit 131.

### Method

The objective of the monitoring method according to the present invention described is to effectively provide help to a monitored person in an emergency situation and to inform the remote caregiver as thoroughly as possible about the situation of the monitored person, without having to invade the privacy of the monitored person too intrusively. In addition, the monitored person should be given the opportunity to acknowledge an alarm before this alarm is transmitted to a remote caregiver.

An emergency situation is triggered by an event 300. An event 300 can be an acute medical problem (e.g., a fall, an injury, a burn, a dizzy or weak spell, immobility, a cardiac problem), on the one hand, or the event can be triggered by an external cause (e.g., smoke emission, fire, water damage, a gas leak, a burglary, electric shock), on the other hand.

The event 300 places the monitored person into an emergency situation. This emergency situation prompts the monitored person to make an active effort to seek help. Generally, this effort is associated with sounds (mechanical sounds and/or human utterances). These sounds, which in this description are referred to as “trigger signals” 301, are detected by the present invention.

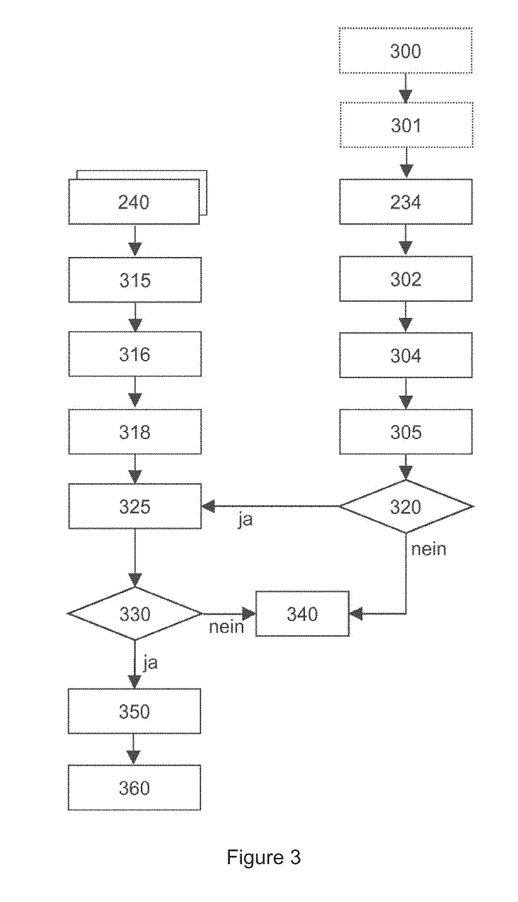

The flow chart in FIG. 3 summarizes the individual steps of the monitoring method according to one possible embodiment. The data processing unit 250 of the electronic monitoring unit 131 (possibly 134, 136, 138 or 139 as well) detects the incoming audio signal 234 and performs data processing of the audio signal 302. To this end, the data are buffered in a data buffer 304. It should be noted that in all cases, only the minimum necessary period of time is buffered for the audio signal. Just a sufficiently large amount of audio material to contain the longest defined trigger signal 301, i.e., as a rule, a few seconds. Even if unauthorized parties were to gain access to this audio signal, it will not be possible to draw any valuable information from this one isolated signal.

As known to those skilled in the art, for the classification 305 of the audio signal in real time, algorithms from sound and voice detection are used.

In this context, the sound detection device of the electronic monitoring unit especially detects previously defined trigger signals 301, such as mechanical sounds (e.g., knocking, clapping, scratching) or human sounds (e.g., wheezing, screaming, moaning) and/or various calls for help (e.g., “Help!”, “Help me!” . . . ).

Trigger signals 301 are sounds which are actively made by the monitored person and which draw attention to the fact that he/she needs help. In most cases, these trigger signals 301 are generated after the event 300 has occurred since they are made by the monitored person in response to the event 300.

Trigger signals 301 can be adapted to the local languages and to locally familiar sounds and utterances that are made in an emergency situation.

Once a trigger signal 301 is detected, the classification module, after a query “Audio alarm?” 320, outputs a result “Audio alarm”. This result may contain additional information about the detected sound, such as the type of the trigger signal and the detection probability. If no trigger signal is detected, the electronic monitoring unit remains at normal status 340 (“Status=ok!”).

In a possible embodiment of the invention, in addition to the audio receiver 324, additional sensor signals 240 (sensor 1 to sensor N) are taken into account. These signals are processed in the electronic monitoring unit 131 (or in 134, 136 or 139 as well) initially in 315 and stored in 316. A storage location can be localized in the electronic monitoring unit or in an external communication device 120 (e.g., cloud, server, smart device . . . ). A data analysis 318 is performed by means of at least one method of sensor fusion, machine learning or statistical analysis or a combination of a plurality of these methods. The objective of the analysis is, for example, to obtain information about the area occupied by the monitored person in the room, and the type and degree of activity the monitored person is engaged in. In addition, the normal behavioral pattern of the monitored person is learned, thereby allowing deviations from this normal behavioral pattern to be detected. The additional sensors 240 are, inter alia, used to make the classification of the audio signal more robust.

The information obtained from the signals of the additional sensors 240 can be used to conduct a plausibility test 325 of the detected audio alarm. A query “Event detected?” 330 leads to a positive or a negative result. A negative test result prevents an alarm and retains the electronic monitoring unit 131 at normal status 340 (“Status=ok!”). A positive test result confirms a detected audio alarm and thereby a previously occurred event 300. The electronic monitoring unit 131 is placed into an alarm status 350 (“Status=Alarm!”) and issues an alarm 360. Together with the alarm 360, other characteristics of the alarm can be transmitted, such as the risk level or the type of the trigger signal (e.g., “Help”, knocking . . . ).

In one embodiment, the system issues a status report at regular intervals, which is locally or externally stored. The monitored person and the remote caregivers can access this information at any time (e.g., on the external communication device) and thereby review the status of the monitored environment 130 and/or the monitored person.

The additional sensors 240 also allow an alarm to be sounded in the event of gradually degenerative conditions or if the normally learned behavioral pattern suddenly changes. In one embodiment, for example, an alarm can also be triggered in the event of a deviation from the normal behavioral pattern over a defined period of time and a defined level. This alarm can also be transmitted at a lower urgency level; for example, in a text message, such as an email or an SMS, instead of a telephone call.

The electronic monitoring unit 131 initiates the alarm method as soon as the unit is in alarm status 350.

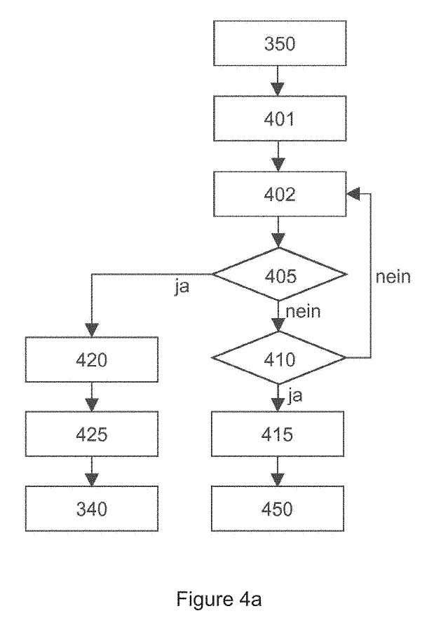

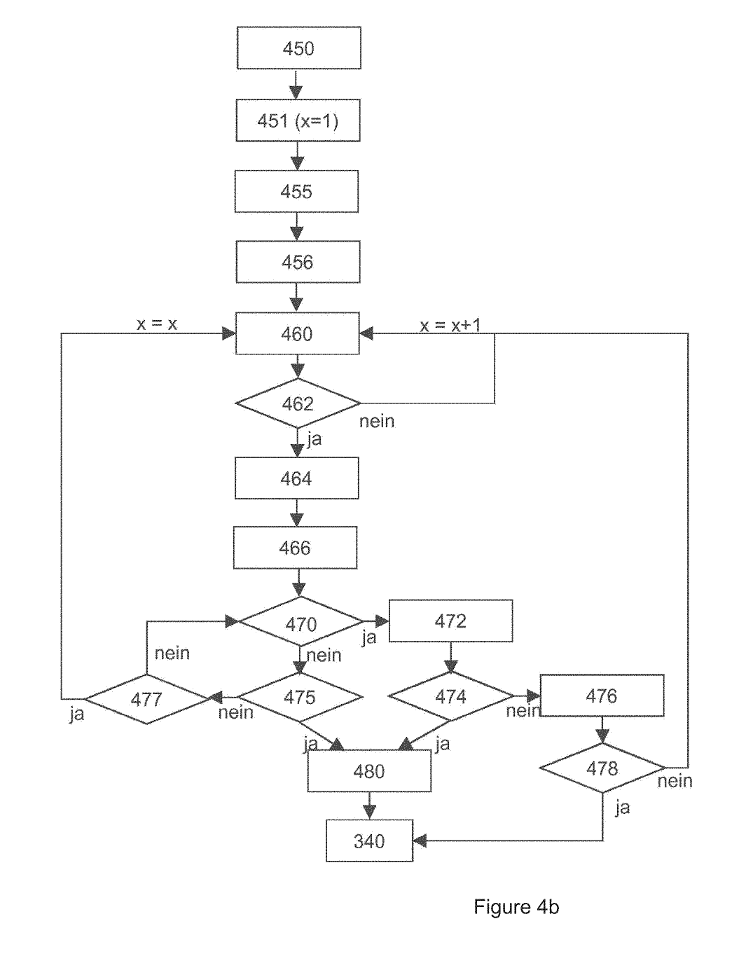

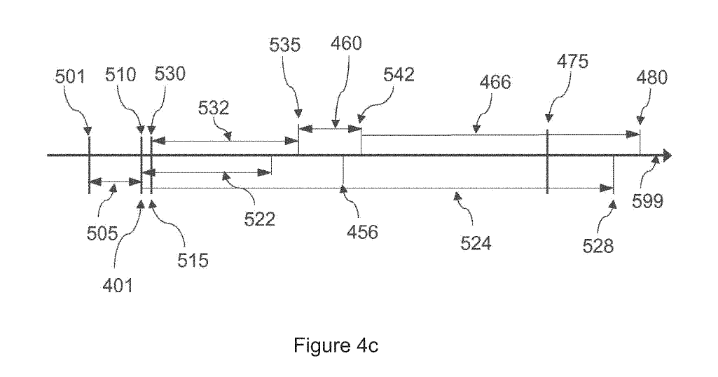

FIG. 4a illustrates this alarm method. As the alarm status 350 is initiated, an audio recording 401 is started, and a local alarm 402 is issued. The monitored person is given the opportunity to stop this alarm by acknowledging it and thereby to intercept false alarms. The monitored person can acknowledge the alarm by means of an acoustic, physical or optical interaction with the system and/or the electronic monitoring unit 131. An acknowledgment signal may be an acoustic signal, such as by voice, or other clearly audible sounds (e.g., whistling, knocking, clapping and the like); in addition, actuating a device on the electronic monitoring unit (e.g., button, switch, key, touchscreen display or the like) can also stop the alarm. Optical signals, such as a gesture made by the monitored person (e.g., waving or the like), can also acknowledge the alarm.

At alarm status, a query 405 “Acknowledged?” is continuously performed. An acknowledgment also stops an audio recording 420, and the system is set to normal status 340. Furthermore, to protect the privacy, the audio recording 425 can be deleted.

The local alarm can be acknowledged before a defined acknowledgment period has expired, which period is checked by a query “Time expired?” 410. If an acknowledgment was not made within the acknowledgment period, the local alarm is terminated 415. The system continues to be in alarm status 350. In the next step, an external alarm 450 is started.

The local alarm can also be transmitted to a module 138, 139 that is installed in the monitored room or via the cloud 120 to a smart device 188 which can be belong to the monitored person.

FIG. 4b describes the method for the external alarm 450. At the beginning, a parameter x is set 451 to value 1. This parameter serves to describe the placement of the remote caregiver on a list of the remote caregivers on file. One or a plurality of lists can be on file, which can be used depending on the type of alarm or depending on the time. Thus, for example, during the night, a list different from the list used during the day can be used. In step 460, the external communication module 284 of the electronic monitoring unit attempts to establish a voice connection with a first person on the list of the remote caregivers.

In addition, an audio file is processed and transmitted in step 456. To this end, the audio recording is processed and converted into a conventional audio file format (e.g., way, mp3, wma). The file may contain either a portion of the audio signals recorded up to this time or the entire audio signal that was recorded up to this time.

This audio file is transmitted via the external communication module 284 by means of conventional data channels, such as an instant messaging service via the Internet or an application via the Internet and/or a mobile radio network (GSM, GPRS, UMTS, LTE).

In addition, the hands-free speaking system 455 is started, and a dialing signal or another confirmation that an external alarm has been executed is audible in the room.

Steps 455, 456 and 460 can be performed in any sequence desired. It is also possible for two or all steps to be carried out at the same time.

Furthermore, it is also possible for only one or a plurality of the steps 455, 456 and 460 to be carried out.

Via a query “Accepted?” 462, it is possible to check whether a voice connection has been established. If the call has been accepted by a robot, for example, a mailbox, the connection can be interrupted. If a voice connection can be established, a recorded message 464 can inform the remote caregiver about the characteristics of the alarm 360. Subsequently, the monitored person is able to communicate 466 with the remote caregiver via the hands-free speaking system of any electronic monitoring unit (master or slave unit).

If it is not possible to establish a voice connection with the remote caregiver 1, each additional remote caregiver on file will be contacted one after the other until the monitored person is connected via a voice connection with a remote caregiver or until the list has been unsuccessfully exhausted.

By means of 456, a portion of or the complete recorded and processed audio signal will be transmitted to each remote caregiver who has been contacted in this method. This information helps the remote caregivers to evaluate the situation and to obtain a better idea about the urgency of the emergency call. Since the remote caregiver frequently is an individual close or related to the monitored person, familiarity with the person can be included as a factor in the evaluation of the audio signal.

The entire audio recording is made available to the remote caregivers via conventional data channels, for example, on the external communication devices 180 and can be reviewed. This provides the remote caregivers with a complete and detailed picture about how the emergency situation developed from the moment at which the monitored person asked for help. As a rule, this moment coincides with the start of the trigger signal 510. In contrast to other monitoring methods, no information is lost even if it takes relatively long to establish a voice connection 460 with a remote caregiver. Therefore, the acknowledgment period 532 can also be set for a random length of time since the loss of valuable information does not pose a risk.

To reset the system to normal status 340 after a voice connection 460 has been established, the alarm status must be actively terminated, for example, by pressing a key or another entry, such as by voice or text, on the external communication device. As an alternative, acknowledgment can also be made by having the remote person hang up the telephone, thereby signaling that no emergency situation exists. The voice connection is supported over a previously defined period of time. If by the end of this period of time, no acknowledgment has been received (which is checked by a query “Time expired?” 470), a command for terminating the alarm status is issued 472 (e.g., by a recorded message). If this command is executed based on a query “Command fulfilled?” 474, the voice connection is terminated 480, and the system is set to normal status 340. If the alarm status is not terminated, the voice connection is also terminated, and the remote caregiver is given the opportunity to call 476 the system. If, based on a query “Call received?” 478, no external call has been received after a certain period of time and the system is still in alarm status, the next remote caregiver on the list is contacted.

If, prior to expiration of the maximum talk time, the alarm status has not yet been terminated and if, based on a query “Voice connection interrupted?” 477, the voice connection is interrupted, the same remote caregiver who was in contact with the monitored person prior to the interruption of the voice connection will be contacted again.

Remote caregivers will be contacted for as long as it takes for the system to be reset to the normal status 340 by a termination of the alarm status 475.

In one embodiment, the unsuccessfully contacted remote caregiver can call the electronic monitoring unit 131 after receiving the audio message. In this case, a voice connection is established without the active acceptance by the monitored person since this person may not be able to actively accept the call. The mode of passively accepting an external call as described herein should be used only if the system is in alarm status 350. This method ensures that after a certain period of time, an external reaction is elicited even if all remote caregivers have been unsuccessfully contacted.

In another embodiment, no attempt is made to establish a voice connection. Only an audio file is sent to one or a plurality of the remote caregivers. After listening to the audio recording, these remote caregivers have the opportunity to call the system and thereby to enter into a direct voice connection with the monitored person.

In yet another embodiment, the audio signal of a recording period Δt1 522 is converted into a text my means of methods of voice-to-text conversion and stored in a text file. This file is subsequently sent by means of conventional data channels, such as an instant messaging service via the Internet or an application via the Internet and/or a mobile radio network (GSM, GPRS, UMTS, LTE), to one or a plurality of remote caregivers. Also, the audio file can be sent in addition thereto.

In another embodiment, in the event of an external alarm 450, the environmental data of the additional sensors 240 are transmitted as additional information along with the audio file or are announced in the recorded message 464 at the beginning of the voice connection 542.

In yet another embodiment of the present invention, a deviation from the normal behavioral pattern is summarized in a characteristic quantity (e.g., probability of the monitored person undergoing a weak spell) and, in the event of an external alarm 450, sent as additional information along with the audio file or announced in the recorded message 464 at the beginning of the voice connection 542.

In one embodiment of the present invention, after a voice connection with a remote caregiver has been successfully established, each previously unsuccessfully contacted remote caregiver is informed that the monitored person has made contact with a remote caregiver. Information about the identity of the remote caregiver and the length of contact and the time of contact can be provided as well. This message is transmitted via conventional data channels, such as email, SMS or WhatsApp.

According to a possible embodiment of this invention which is illustrated in FIG. 4c, the time sequence of the steps in the event of an alarm is shown in detail. All steps are arranged on a timeline 599. An event 300 which places a monitored person into an emergency situation begins at time t0 501. After this time t0 501, there is a time delay Δt0 505 since the monitored person responds after a certain reaction time to the event 300. This delay 505 can last for the shortest possible time and for the longest possible time. A monitored person may call for help while he/she is in the process of falling or he/she may call only a few minutes or hours after he/she has regained consciousness after having fainted.

The reaction of the monitored person to the event is the trigger signal 301 with a beginning 510 and an end 515. This end is a trigger point in time t1 515. At the trigger point in time t1 515, a local alarm 402 is issued. This is implemented by an alarm signal as described above. The beginning of a local alarm is the beginning of an acknowledgment period 530. This point in time 530 need not necessarily coincide with the trigger point in time 515 but it can at the earliest occur with the trigger signal. An acknowledgment period Δt2 532 can be set for any length of time and, if advisable, can be adjusted to the risk level of the emergency situation.

After expiration of the acknowledgment period 535 without an acknowledgment by the monitored person, an external communication is started. The establishment of a voice connection 460 precedes the beginning of the voice connection 542 and can be set for any length of time if a remote caregiver cannot be reached.

Before the voice connection 480 can be terminated, the alarm status 475 must be terminated. This termination can take place at any time after the local alarm has been issued. The alarm status 475 can, however, also be terminated by the monitored person or by the remote caregiver. As a rule, the remote caregiver will terminate the alarm status 475 after the beginning of the voice connection 542 and before the end of the voice connection 480.

At the trigger point in time 515, an audio recording is started, in which the trigger signal 301 is included. This is implemented in that the buffered signal from the data buffer 304 is now permanently saved and stored and represents the first portion of the audio recording. The audio recording 524 can proceed for any length of time but, as a rule, it is terminated prior to or with the end of the voice connection.

After expiration of a recording period Δt1 522, a first portion of the audio recording is processed for transmission to remote caregivers. As a rule, the duration of the recording period Δt1 522 ends with the beginning of a voice connection 542, but it can also be terminated before or only after the end of the audio recording 528.

### LIST OF REFERENCE CHARACTERS

100 Monitoring system (comprising an electronic monitoring unit and at least one additional module (e.g., slave unit, sensor module))
120 Internet, cloud, server, telephone line, mobile radio network
130 Monitored environment
131 Electronic monitoring master unit
134 Electronic monitoring slave unit
136 Independent electronic monitoring master unit (in addition to 131)
137 Smart device (for configuration)
138 Sensor or actor module
139 Mobile modules (e.g., robots, for example, with artificial intelligence)
180 External communication devices
182 Device, for example, with artificial intelligence
184 Emergency call center
186 Telephone
188 Smart device (e.g., smartphones, tablets, smartwatches)
230 Hands-free speaking system
232 Loudspeaker
234 Audio receiver
236 Device for issuing a local alarm
238 Device for acknowledgment
240 Additional sensors
250 Data processing unit
260 Hardware module of the data processing unit
270 Software module of the data processing unit
282 Internal communication module
284 External communication module
300 Event
301 Trigger signal
302 Data processing of the audio signal
304 Data buffer
305 Classification
315 Data processing
316 Data storage
318 Data analysis (by means of machine learning and/or sensor fusion)
320 Query “Audio alarm?”
325 Plausibility test
330 Query “Event detected?”
340 Normal status (Status=ok!”)
350 Alarm status (Status=alarm!”)
360 Issuance of an alarm
401 Beginning of the audio recording
402 Issuance of a local alarm
405 Query “Acknowledged?”
410 Query “Time expired?”
415 End of the local alarm
420 End of the audio recording
425 Deletion of the audio recording
450 Issuance of an external alarm
451 Set parameter x=1 (x describes the placement of the remote caregiver on the list of remote caregivers)
455 Start of the hands-free speaking system
456 Processing and transmission of an audio file (portion of or complete audio recording)
460 Establishment of a voice connection with a remote caregiver x
462 Query “Accepted?”
464 Recorded message (contains information about the emergency situation and the monitored person)
466 Communication via the hands-free speaking system
470 Query “Time expired?”
472 Command to end the alarm status
474 Query “Command fulfilled?”
475 Query “Alarm status ended?”
476 End of the voice connection with the possibility of calling the remote caregiver
477 Query “Voice connection interrupted?”
478 Query “Call received?”
480 End of the voice connection
501 Event point in time t0 (beginning of the emergency situation)
505 Delay Δt0
510 Start of the trigger signal
515 Trigger point in time t1 (end of the trigger signal)
522 Recording period Δt1 (for transmitting a certain portion of the recording 524)
524 Audio recording
528 End of the audio recording
530 Beginning of the acknowledgment period Δt2
532 Acknowledgment period Δt2
535 End of the acknowledgment period Δt2
542 Start of the voice connection
599 Timeline

1-12. (canceled)

13. A monitoring method for monitoring a person by an electronic monitoring unit in a room, wherein the electronic monitoring unit comprises a hands-free speaking system and at least one audio module so that audio signals of the monitored person can be detected and analyzed and, on detection of an event, a communication connection with at least one remote caregiver can be established, the method comprising:
continuous detecting the audio signals in the operating status without recording of the audio signals;
continuous checking of the detected audio signals in real time for previously defined trigger signals indicating an event so that
after identification of the defined trigger signal at a trigger point in time by the electronic monitoring unit, which trigger signal indicates an event at an event point in time prior to the trigger point in time, the electronic monitoring unit automatically
starts recording an audio file over a recording period of time after the trigger point in time; and
submits an acknowledgment query to the monitored person for an acknowledgment period after the trigger point in time, which acknowledgment query is transmitted in the form of an acoustic or optical acknowledgment signal to the monitored person, wherein, only on failure of an acknowledgment by the monitored person after expiration of the acknowledgment period, active intervention by the monitored person on an acknowledgment device which is connected to the electronic monitoring unit,
causes the electronic monitoring unit to be put on alarm status and to start an external alarm signal in the form of the electronic monitoring unit establishing contact with at least one remote caregiver,
so that the alarm status can be terminated by the at least one contacted remote caregiver after a direct voice connection with the electronic monitoring unit has been established,
wherein, after acknowledgment of the acknowledgment query has been made by the monitored person within the acknowledgment period, the electronic monitoring unit is programmed such that: no alarm status is triggered, the acknowledgment query is stopped, the audio recording is stopped, the audio file is deleted, and the electronic monitoring unit is reset to the normal status.

14. The monitoring method of claim 13, wherein, after the unacknowledged expiration of the acknowledgment period, the alarm status in the form of the establishment of contact by the electronic monitoring unit with the at least one remote caregiver is designed in such a manner that:
the audio file recorded within the recording period is transmitted by the electronic monitoring unit and an instant messaging service via the Internet or an application via the Internet and/or a mobile radio network (GSM, GPRS, UMTS, LTE) to the at least one remote caregiver in the form of an indirect voice message; and/or
the electronic monitoring unit establishes a direct voice connection between the at least one remote caregiver and the electronic monitoring unit by the instant messaging service via the Internet or the application via the Internet and/or the mobile radio network.

15. The monitoring method of claim 14, wherein only the audio file recorded within the recording period is transmitted by the electronic monitoring unit to the at least one remote caregiver and, after the at least one remote caregiver has listened to the recorded audio file, if needed, a direct feedback voice connection to the electronic monitoring unit is established by the instant messaging service via the Internet or a mobile radio network (GSM, GPRS, UMTS, LTE) by the at least one remote caregiver to the electronic monitoring unit, by which feedback the alarm status of the electronic monitoring unit is terminated and the event and/or the further method to be followed is discussed.

16. The monitoring method of claim 14, wherein after transmission of the recorded audio file and/or the establishment of a direct voice connection, the failure to contact a first remote caregiver is fed back by the instant messaging service and/or the application and/or by the mobile radio network, and an attempt is made to establish the indirect and/or direct voice connection to another remote caregiver until indirect and/or direct voice connection with the another remote caregiver is established.

17. The monitoring method of claim 16, wherein after establishment of a direct voice connection between the at least one remote caregiver and the monitored person, an all-clear information is transmitted by the electronic monitoring unit by the instant messaging service via the Internet or the application via the Internet and/or the mobile radio network (GSM, GPRS, UMTS, LTE) to the remote caregivers who had not been reached.

18. The monitoring method of claim 13, wherein the recorded audio file is converted by voice-to-text conversion into a text file and the text file, together with the audio file, is transmitted by the electronic monitoring unit and the instant messaging service via the Internet or the application via the Internet and/or the mobile radio network (GSM, GPRS, UMTS, LTE) to the remote caregiver.

19. The monitoring method of claim 13, wherein the detected audio signals are analyzed and further processed in the audio module by methods of voice recognition.

20. The monitoring method of claim 13, wherein the electronic monitoring unit interacts with at least one additional set of electronic sensors in a different area of the room or in a room in the form of master-slave architecture, with the electronic sensors transmitting audio signals and environmental data from the other area of the room or from the other room to the electronic monitoring unit.

21. The monitoring method of claim 13, wherein environmental data are continuously recorded by additional sensors in the room and routed to the electronic monitoring unit so that the environmental data are transmitted as part of the external alarm signal with the recorded audio file via the electronic monitoring unit to the remote caregiver.

22. The monitoring method of claim 21, wherein, based on the continuous recording of the environmental data in the electronic monitoring unit, over time normal behavioral patterns of the monitored person are established so that information about behavior deviating from the normal behavior of the monitored person prior to the event is transmitted along with the transmission of the external alarm signal.

23. The monitoring method of claim 13, wherein the acknowledgment on the electronic monitoring unit takes place:
mechanically, by pressing a key or a touchscreen display; or
acoustically by uttering an acknowledgment word or sentence.

24. The monitoring method of claim 20, wherein the electronic monitoring unit and/or the at least one additional set of electronic sensors are supplied with power by a connection to a stationary power network.

25. The monitoring method of claim 21, wherein the additional sensors selected from the group consisting of temperature sensors, CO₂ sensors, other gas sensors, humidity sensors, motion sensors, cameras, and combinations thereof.
